(19) United States
(12) Patent Application Publication
(10) Pub. No.: US 2006/0070120 A1
(43) Pub. Date: Mar. 30, 2006

(54) File transmitting device and multi function device

(75) Inventors: Kazuma Aoki, Aichi-ken (JP); Yuji Sato, Aichi-ken (JP)

Correspondence Address: BANNER & WITCOFF, 1001 G STREET N W, SUITE 1100, WASHINGTON, DC, 20001, US

(73) Assignee: BROTHER KOGYO KABUSHIKI KAISHA, Aichi-ken (JP)

(21) Appl. No.: 11/217,424

(22) Filed: Sep. 2, 2005

(30) Foreign Application Priority Data
Sep. 2, 2004 (JP) 2004-256330
Sep. 2, 2004 (JP) 2004-256331

(51) Int. Cl. H04L 9/32

(52) U.S. Cl. 726/4

(57) ABSTRACT

A file transmitting device is configured to transmit a designated file to an external device. The file transmitting device includes a file storage configured to store files to be laid open, and a communication system. The file transmitting device can communicate with the external device through a network. The file transmitting device further includes a file retrieving system that retrieves the designated file from the file storage, a judging system configured to judge whether the retrieved file is a confidential file based on word information included in the retrieved file, and a controlling system configured to apply an appropriate security process to the retrieved file in accordance with a result of judging of the judging system. The retrieved file is transmitted to the external device through the network.

### CROSS REFERENCE TO RELATED APPLICATIONS

This application claims priority from Japanese Patent Applications No. 2004-256330 and No. 2004-256331, both filed on Sep. 2, 2004. The entire subject matters of the applications are incorporated herein by reference.

### BACKGROUND

1. Technical Field

Aspects of the invention relate to a file transmitting device configured to transmit files, which have been stored in the file transmitting device. Aspects of the invention also relate to a multi-function device (MFD) provided with a plurality of information receiving/outputting systems and capable of accumulating received information and outputting the same afterward.

2. Related Art

Recently, a complex information processing device having a plurality of functions in one device has been developed and used. Such a device, generally known as a multi-function device (MFD) typically has functions of a facsimile device for transmitting/receiving facsimile image data, a scanner for reading an image to create image data and a printer for printing an image based on image data received form an external device. Some of the MFDs may have a data accumulating function which is a function for accumulating received data and outputting the accumulated data afterward.

An example of such an MFD is disclosed in Japanese Patent Provisional Publication No. HEI 11-195128 (hereinafter referred to as '128 publication). The MFD disclosed in the '128 publication is capable of generating a web page based on a predetermined text and images by a relatively easy operation such as one for printing or copying so that the text and/or image can be published easily. According to the MFD disclosed in the '128 publication, text described with a page description language (such as a PostScript) and/or images scanned by a scanner are converted into HTML files and JPEG files, which are stored in a hard disk drive. When a browsing request is received from a computer on the network, the MFD transmits the HTML files and JPEG files to the requesting computer through the network.

According to the MFD disclosed in the '128 publication, information can be published through a web sited easily since the web pages can be automatically created when a user carries out a printing operation and a copying operation

The above-described configuration of the MFD is, however, problematic in view of security of information since the processed data can be published very easily. Typically, to deal with the security problem, a password may be set for each file stored in the hard disk drive. In this case, every time when a user attempts to open the file, a password should be input. An example of such a system is disclosed in Japanese Patent Provisional Publication No. HEI 7-184068 (hereinafter, referred to as '068 publication). Alternatively, users may be filtered using a password so that only predetermined users can access the files stored on the hard disk drive.

The former method, i.e., assigning a password is set for each file, is troublesome since different passwords should be set to the stored files, respectively, when the files are stored in the hard disk drive or after the files are stored. Further, if the password is not set to an important file, it can be accessed by anyone. If a password is set to a file which is intended to be accessed by anyone, the password prevents the file from being laid open.

The alternative method works well when the users access the files through an intranet. However, if the user wish to access the file outside the intranet (e.g., through the Internet), it may be problematic since the password is input through a public network. Further, it may also be a problem if the user fails to set the password, in that the stored files can be accessed by anyone.

### SUMMARY

Aspects of the present invention provide an improved file transmitting system that maintains confidentiality and, at the same time, enables publication of files appropriately without requiring troublesome operation by the user.

### BRIEF DESCRIPTION OF THE ACCOMPANYING DRAWINGS

FIG. 1 is a block diagram schematically showing a configuration of a file network system according to aspects of the present invention.

FIG. 2 is a block diagram showing a configuration of an MFD (multi-function device) according to aspects of the present invention.

FIGS. 3A, 3B and 3C show field lists of content table, data table and keyword table, respectively, according to aspects of the present invention.

FIG. 4 shows a data structure of the keyword table according to aspects of the present invention.

FIG. 5 shows a flowchart illustrating a browsing procedure according to aspects of the present invention.

FIGS. 6 and 7 show a flowchart illustrating a browsing screen generating procedure according to aspects of the present invention.

FIG. 8 shows a flowchart illustrating a confidential keyword checking procedure according to aspects of the present invention.

FIG. 9 shows an example of a log-in window according to aspects of the present invention.

FIG. 10 shows an example of a search window according to aspects of the present invention.

FIG. 11 shows an example of a browse window according to aspects of the present invention.

FIGS. 12A and 12B show examples of input windows for adding/deleting keyword to be stored with being connected with a file according to aspects of the present invention.

FIGS. 13A and 13B show examples of input windows for adding/editing confidential keywords according to aspects of the present invention.

FIG. 14 shows an example of an operation window when a printing operation is carried out according to aspects of the present invention.

FIG. 15 shows an example of an operation window when a PC-FAX is transmitted according to aspects of the present invention.

FIG. 16 shows an example of an operation window when a scanner function is used according to aspects of the present invention.

FIG. 17 shows an example of an operation panel according to aspects of the present invention.

### DETAILED DESCRIPTION

General Overview of Aspects of the Invention

It is noted that various connections are set forth between elements in the following description. It is noted that these connections in general and unless specified otherwise, may be direct or indirect and that this specification is not intended to be limiting in this respect.

According to aspects of the invention, a file transmitting device is provided that is configured to transmit a designated file to an external device, which is provided with a file storage configured to store files to be laid open, a communication system connected to a network, the file transmitting device being able to communicate with the external device through the network, a file retrieving system that retrieves the designated file from the file storage, a judging system configured to judge whether the retrieved file is a confidential file based on word information included in the retrieved file, and a controlling system configured to apply an appropriate security process to the retrieved file in accordance with a result of judging of the judging system, the retrieved file being transmitted to the external device through the network. The security process applied to the file may be a password setting, incorporation of information regarding copyright protection, or deletion of confidential parts from the contents of the file.

According to the above configuration, since it is not necessary to set a security attribution to a file, but the confidentiality can be maintained. Further, whether the file is confidential or not is judges based on the word information contained in the file, accordingly, an error of the user (administrator) will not occur. Therefore, problems such that a confidential file is erroneously laid open as the password has not been set or a public file is erroneously confidential as the password has been set will not occur. Furthermore, since no particular operation is required when a file is stored in the storage, the file is stored quickly at a desired state.

The controlling system may be configured to inhibit transmitting the retrieved file if the judging system determines that the retrieved file is a confidential file.

As above by not transmitting the confidential file, the confidentiality can be protected perfectly.

The file transmitting device may further include a keyword storage configured to store a predetermined keyword, and the judging system may judge that the file is the confidential file if the predetermined keyword is included in the file, while the judging system judges that the file is a non-confidential file if the predetermined keyword is not included in the file.

With the above configuration, simply by changing the keyword stored in the keyword storage, the condition can be changed in various ways. Further, even in such a case, it is not necessary to change each file itself. Only by changing the confidential keywords, the judgment condition can be changed, which is convenient and less troublesome in comparison with the conventional system. If the keywords are stored in the storage when the file transmitting device is shipped from the manufacturer, the user of the device can immediately enjoy the merit of the configuration. Even if the user is not familiar with the security problems, file transmission can be done with maintaining the confidentiality.

The file transmitting system may further include a receiving system configured to receive (i.e., allow a user to input) a word equivalent to the confidential keyword stored in the keyword storage and stores the received word in the keyword storage as the confidential keyword.

With this configuration, the user can easily add a keyword equivalent to the confidential keyword stored in the keyword storage. Therefore, the user can immediately change the judgment condition when necessary.

The keyword storage may further store a predetermined condition in association with each confidential keyword, and the judging system may judge with taking the predetermined condition into account. This configuration may enhance flexibility in judging whether a file is a confidential file or not.

The predetermined condition the keyword storage stores may include a type of a network which is used when the control system transmits the file to the external device via the communication system. Generally, one of the highly required security controls is one for distinguishing the network types of the destinations. With the above configuration, when a file is to be transmitted, the method of protecting the file and/or whether the file is to be transmitted or not can be controlled easily depending on the type of the network used.

The network may include a local area network and a wide area network. Further, the wide area network may include a virtual private network. With this configuration, for example, a confidential file may be transmitted as it is when sent through the LAN, while the protective setting is applied when the file is transmitted through the WAN.

The predetermined condition stored in the keyword storage may include locations of the confidential keyword if contents of the file is displayed or printed. The location may be a header portion, a tile portion, a paragraph tile portion, a body portion, a footer portion, a copyright indicating portion, etc. Generally, when a confidential keyword “CONFIDENTIAL” is indicated in a document, its meaning may be different depending on a location (at the header, body, footer, etc.) where the keyword is indicated. Therefore, if such a location condition is also taken into account when the judgment is made, the judgment is made more flexible.

Alternatively or optionally, the predetermined condition stored in the keyword storage may include a color of the confidential keyword if contents of the file is displayed or printed. Generally, when a confidential keyword “CONFIDENTIAL” is indicated in a document, its meaning may be different depending on a color. Therefore, if such a color condition is also taken into account when the judgment is made, the judgment is made more flexible.

Alternatively or optionally, the predetermined condition stored in the keyword storage may include the number of occurrences of the confidential keyword if contents of the file is displayed or printed. Generally, when a confidential keyword “CONFIDENTIAL” is indicated in a document, the degree of importance may be different depending on the number of occurrences in a text. That is, if the keyword appears a plenty of times, the confidentiality may be serious in comparison with a case where the keyword is used once or twice. Therefore, if such a number of occurrence conditions are also taken into account when the judgment is made, the judgment is made more flexible.

Alternatively or optionally, the predetermined condition stored in the keyword storage may include includes the size of the confidential keyword if contents of the file is displayed or printed. Generally, when a confidential keyword “CONFIDENTIAL” is indicated in a document, the degree of importance may be different depending on the size of the keyword. That is, if the keyword in indicated with larger letters, the confidentiality may be serious in comparison with a case where the keyword is small. Therefore, if such a size condition is also taken into account when the judgment is made, the judgment is made more flexible.

The file transmitting system may further include a receiving system configured to allow a user to input a word equivalent to at least one of the confidential keyword and the predetermined condition stored in the keyword storage and stores the received word, which represents the at least one of the confidential keyword and the predetermined condition in the keyword storage. With this configuration, the user can easily add a keyword equivalent to the confidential keyword stored in the keyword storage. Therefore, the user can immediately change the judgment condition when necessary.

The file transmitting device may further include a keyword storage configured to store a predetermined confidential keyword. The file storage also stores in-text keyword information containing some of keywords, in association with the file, included in the file. The judging system may judge the file as the confidential file if the predetermined confidential keyword is included in the in-text keyword information corresponding to the file, while the judging system judges the file as the non-confidential file if the predetermined confidential keyword is not included in the in-text keyword information corresponding to the file.

The keyword may be nouns extracted from the text contained in the file by executing syntactic parsing when the file is stored in the storage. Alternatively or optionally, the keyword may include nouns extracted from the text with reference to dictionaries.

With this configuration, when the file is transmitted, it is not necessary to scan the entire content of the file, but only the in-text keyword information, which is smaller in size of the entire text of the file, is to be scanned. Therefore, the scanning can be completed within a relatively short period. Thus, the file can be transmitted with a high response.

The file transmitting system may further include a receiving system configured to receive a word equivalent to the confidential keyword stored in the keyword storage and stores the received word in the keyword storage as the confidential keyword.

The keyword storage may further store a predetermined condition in association with each confidential keyword, and the judging system may judge with taking the predetermined condition into account.

The file transmitting system may further include a receiving system configured to receive a word equivalent to at least one of the confidential keyword and the predetermined condition stored in the keyword storage and stores the received word, which represents the at least one of the confidential keyword and the predetermined condition in the keyword storage.

According to other aspects of the invention, there is provided a file network system, which is provided with a file transmitting device configured to transmit a file through a network, and a terminal device configured to communicate with the file transmitting device through the network, the terminal device being capable of requesting the file transmitting device to transmit a file and receiving the transmitted file through the network. Further, the file transmitting device may include a file storage configured to store files to be laid open, a communication system connected to the network, the file transmitting device being able to communicate with the terminal device through the network, a file retrieving system that retrieves the file requested by the terminal device from the file storage, a judging system configured to judge whether the retrieved file is a confidential file based on word information included in the retrieved file, and a controlling system configured to apply an appropriate security process to the retrieved file in accordance with a result of judgment by the judging system, and transmit the retrieved file to the terminal device through the network.

Aspects of the invention also provide a file network system, provided with a file storage configured to store files to be laid open, a file transmitting device, and a terminal device capable of communicating with the file transmitting device. The terminal device is capable of requesting the file transmitting device to transmit a designated file. Further, the file transmitting device may include a file retrieving system configured to retrieve the designated file from the file storage in response to the request from the terminal device, a judging system configured to judge whether the retrieved file is a confidential file based on word information included in the retrieved file, and a controlling system configured to apply an appropriate security process to the retrieved file in accordance with a result of judgment of the judging system, the retrieved file being transmitted to the terminal device.

According to further aspects of the invention, there is provided a multi-function device configured to execute a plurality of functions, which includes a data storage configured to store input data, the stored data being able to be output afterward to a terminal device through a predetermined network, and a control system configured to execute one of a plurality of predetermined security processes, when the data is to be output, in accordance with a type of the predetermined network, the data being transmitted to the terminal device in accordance with a result of the executed predetermined security process. It should be noted that, depending on the result of the executed predetermined security process, the data may not be transmitted to the terminal device.

With the above configuration, since the security processes can be performed depending on the type of the network to which the destination terminal device is connected. Therefore, the user need not set distinctive passwords or the like when storing various pieces of data in the multi-function device. Further, unlike the method using a unique password for each user, even for the same user, the security level can be varied depending on the location where the user browses the data. That is, based on where the user browses the data, an appropriate security level is selected without changing the data, which is very convenient and less troublesome in comparison with the conventional security system.

The control system may judge whether the predetermined network is a LAN or a WAN, and executes a predetermined security process corresponding to the result of judgment.

It is sometimes required to differentiate the security processes in transmitting files in response to requests from the LAN and WAN. With the above configuration, the security processes can be varied depending on the network to which the terminal devices are connected. For example, the type of the network may be distinguished with reference to the network address of the IP address. With such a simple judgment, the requirement in the security process can be fulfilled. It should be noted that, even though the judging process is easy, the security process may be practically sufficient in most cases.

The control system may judge whether the predetermined network is a LAN, a WAN or a VPN configured on the WAN, and executes a predetermined security process corresponding to the result of judgment. It is of course possible to distinguish the WAN (which is not VPN) and the VPN on the WAN. Therefore, the security process may be varied whether the network to which the terminal device is connected is WAN (non-VPN) or VPN on the WAN. This is also practically sufficient in most cases.

The predetermined security process may include an authentication process corresponding to the type of the predetermined network judged by the control system. With employing the authentication process (e.g., one using user ID and password, biometrics authentication such as fingerprint authentication and the like), the security requirement can be fulfilled without requiring considerable burden to the user.

The control system may not execute the predetermined security process if the type of the predetermined network is a predetermined type. Generally, the LAN is configured such that leakage or modification of data would hardly occur, and even if it occurs, it would cause a relatively minor problem in many cases. Therefore, when the terminal device is connected to the LAN, it would be convenient if the security process is omitted since troublesome operations of the user or burdensome operation of the MFD can be reduced.

The control system may execute the predetermined security process in accordance with attribution assigned to the data to be output in addition to the type of the network. According to this configuration, the user can reflect the user's intention in selecting the security process. That is, if the user intends that predetermined data can be browsed by terminals on the LAN but not browsed by those on the WAN, it becomes possible to set such an attribution to the predetermined data.

The multi-function device may further include an attribution assigning system configured to assign attribution to data when the data is input to the multi-function device, and an attribution storing system that stores the attribution assigned to the data in association with the data. According to this configuration, in comparison with a case where the attribution is assigned to all the pieces of data after they have been stored in the MFD, a time lag between the storage of the data and assignment of the attribution can be shortened, which improves the degree of security, and further, erroneous setting may be avoidable.

The multi-function device may further include an operation acquiring system that acquires an operation of a user, the attribution assigning system assigning the attribution to the data in accordance with the operation performed by the user.

The multi-function device may further include an automatic receiving system configured to automatically receive input data and store the received data, the attribution assigning system assigning attribution to the automatically received data based on information regarding a sending source of the automatically received data. With this configuration, even for data which is automatically stored and cannot be handed by the user when stored, the attribution can be assigned. Therefore, even for such data, the security process can be applied in various ways.

The attribution assigning system may include data representing a correspondence between telephone numbers and corresponding attribution settings. When the automatically received data is facsimile data using a facsimile receiving function, the attribution assigning system identifies an attribution setting corresponding to a telephone number of a sending station of the facsimile data from among the data representing the correspondence between telephone numbers and corresponding attribution settings, the identified attribution setting being stored in the attribution storing system.

According to further aspects, there is provided a file network system, which is provided with a file transmitting device, and a terminal device connected with the file transmitting device through a predetermined network. The file transmitting device may include a data storage configured to store input data, the stored data being able to be output to the terminal device through the predetermined network, a condition detecting system configured to detect a condition regarding a file transmission from the file transmitting device to the terminal device through the predetermined network, and a control system configured to execute one of a plurality of predetermined processes, when the data is to be output, in accordance with the condition detected by the condition detecting system, the data being transmitted to the terminal device in accordance with a result of the executed predetermined process.

The condition regarding the file transmission may include an attribution of the data to be transmitted. Alternatively or optionally, the condition regarding the file transmission may include a type of the predetermined network. Further, the predetermined process may include an authentication process. The predetermined process may include a process for applying a security setting to the data to be transmitted.

According to further aspects, there is provided a computer-readable medium having a program stored thereon, the program comprising computer readable instructions that cause a computer to execute a file transmitting process for transmitting a designated file to an external device which is connected to the computer through a predetermined network, the instructions cause the computer to judge whether the file to be transmitted is a confidential file based on word information included in the retrieved file, and to apply an appropriate security process to the retrieved file in accordance with a result of judgment, the file being transmitted to the external device through the predetermined network.

According to further aspects, there is provided a computer-readable medium having a program stored thereon, the program comprising computer readable instructions that cause a computer to execute a file transmitting process for transmitting a designated file to an external device which is connected to the computer through a predetermined network, the instructions cause the computer to detect a type of the predetermined network, and to execute one of a plurality of predetermined security processes, when the data is to be output, in accordance with a type of the predetermined network, the data being transmitted to the terminal device in accordance with a result of the executed predetermined security process.

### EMBODIMENT

Referring to the accompanying drawings, an illustrative embodiment of the invention will be described in detail.

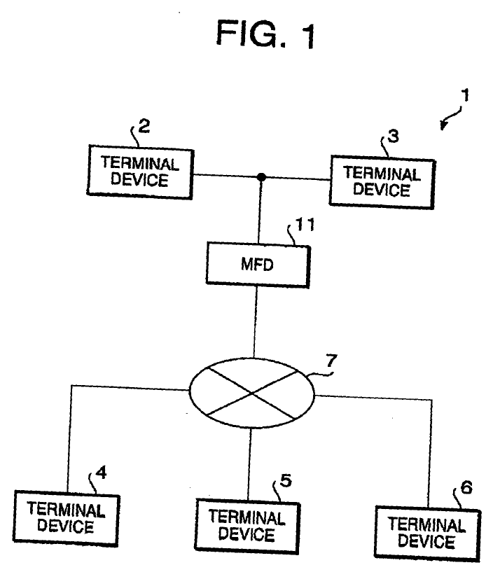

FIG. 1 shows a block diagram showing a configuration of a file network system according to aspects of the present invention. As shown in FIG. 1, the file network system 1 includes the Internet 7, an MFD (Multi-function Device) 11 connected to the Internet 7, terminal devices 2 and 3 connected to the MFD 11 through a LAN (Local Area Network) and terminal devices 4, 5 and 6 connected to the Internet 7.

Each of the terminal devices 2, 3, 4, 5 and 6 is a personal computer having a main body (not shown) provided with a control unit, a monitor (not show) having a displaying function and a keyboard (not shown) having an input function. The terminals 4, 5 and 6 may be WAN (Wide Area Network) connection devices or VPN (Virtual Private Network) connection devices.

In the following description, the MFD 11, which is a main device of the file network system 1, will be described in detail.

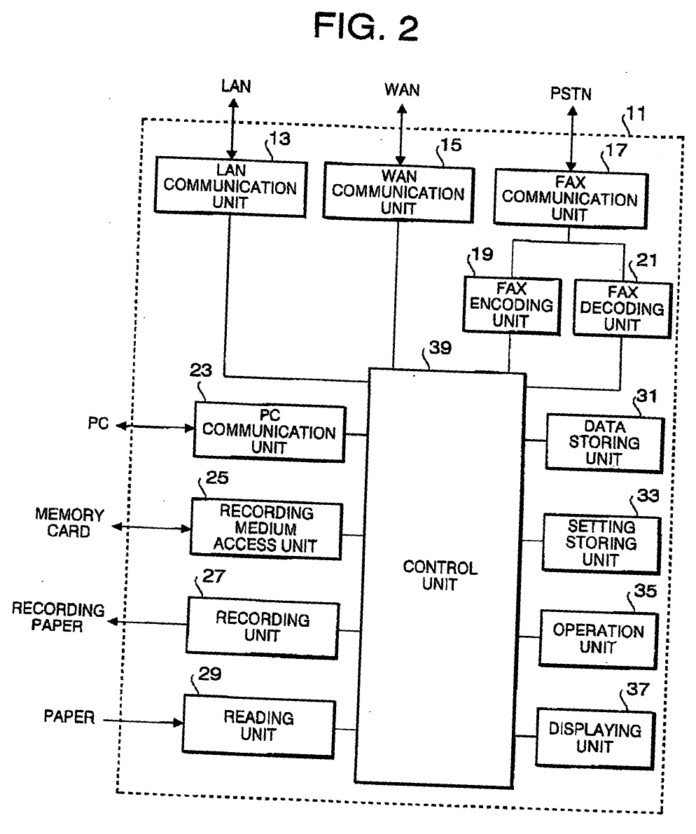

FIG. 2 is a block diagram showing a configuration of the MFD 11. The MFD 11 has a LAN communication unit 13, a WAN communication unit 15, a FAX communication unit 17, a FAX encoding unit 19, a FAX decoding unit 21, a PC communication unit 23, a recording medium access unit 25, a recording unit 27, a reading unit 29, a data storing unit 31, a setting storing unit 33, an operation unit 35, a display unit 37 and a control unit 39.

The LAN communication unit 13 is connected with the LAN, and communicates with various devices which are also connected with the LAN. The WAN communication unit 15 is connected with the WAN and communicates with various devices which are also connected with the WAN. The WAN communication unit 15 also carries out a data processing (encoding/decoding) regarding the VPN. The WAN communication unit 15 also notifies information for distinguishing a VPN communication to the control unit 39.

The FAX communication unit 17 is connected to a PSTN (Public Service Telephone Network) and transmits encoded data, which is received from the FAX encoding unit 19, to another device connected to the PSTN, and data received from another device connected to the PSTN to the FAX decoding unit 21.

The FAX encoding unit 19 encodes data received from the control unit 39 in accordance with a facsimile standard and sends the encoded data to the FAX communication unit 17. The FAX decoding unit 21 decodes the data received from the FAX communication unit 17 in accordance with the facsimile standard so that the received data is decoded into data which can be processed by the control unit 39, and transmits the decoded data to the control unit 39.

The PC communication unit 21 has a function of communicating with a personal computer, under control of the control unit 39, in accordance with a predetermined communication standard such as a USB or IEEE1394.

The recording medium access unit 25 accesses a memory card (or another recording medium), under control of the control unit 39, to retrieve data therefrom and/or to store data therein.

The recording unit 27 has a function of forming images, under control of the control unit 39, on a recording sheet in accordance with a predetermined image formation method such as an electrophotographic imaging method, inkjet printing method and the like.

The reading unit 29 is provided with an image capturing element such as a CCD (Charge Coupled Device) and, under control of the control unit 39, the reading unit 29 captures an image formed on an original (e.g., a printed image on a sheet of paper) and generates image data representing the captured image.

The data storing unit 31 includes, for example, a hard disk, and stores/retrieves data in/from the hard disk under control of the control unit 39. In particular, the data storing unit 31 includes a content table storing attribution data of input data, a data table storing the input data, and a keyword table storing keyword information included in the input data. For example, when the MFD 11 receives FAX data, data regarding the attribution of the FAX data is stored in the contents table, and the received FAX data is stored as is in the data table.

Further, in the keyword table, keywords included in the FAX data are stored. It should be noted that, according to the illustrative embodiment, the keywords are extracted as follows. Firstly, the FAX data (which is image data) is processed using OCR (Optical Character Recognition) software to obtain text data. Then, a syntactic analysis is applied to the thus obtained text data, and keywords are extracted in accordance with a predetermined extracting condition. The similar procedure is performed if the input data is data (e.g., print data) other than the FAX data. Of course, if text data is directly input, the OCR processing is omitted.

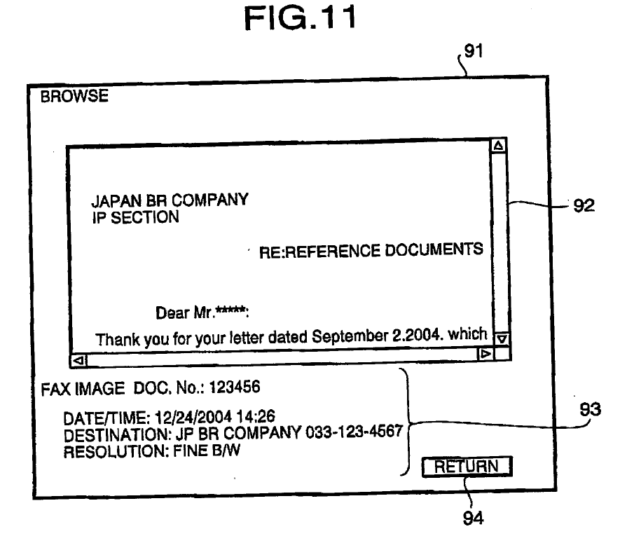

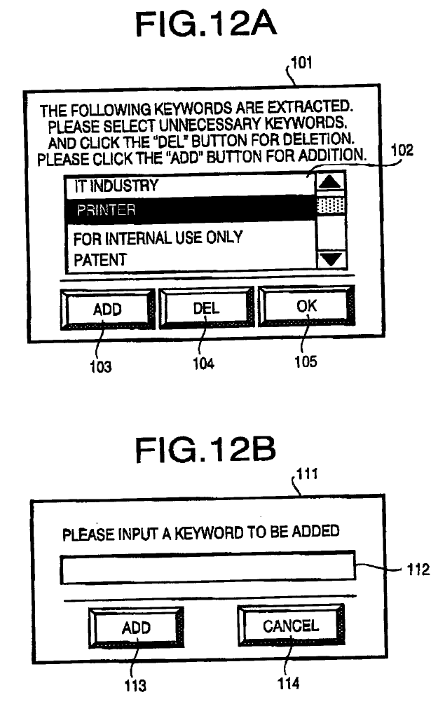

When the keywords are stored in the keyword table, an inquiry message, which inquires whether the extracted keywords should be stored, is displayed on a monitor of a terminal device that has asked the MFD to process the data and/or the operation unit 35 of the MFD 11. The inquiry message will be described with reference to examples shown in FIGS. 12A and 12B. When extraction of keywords has been finished, a confirmation window 101 as shown in FIG. 12A is displayed (for example, on the monitor of the terminal device). According to the example shown in FIG. 12A, the confirmation window 101 includes a list box 102, an “ADD” button 103, a “DEL” button 104 and an “OK” button 105.

In the list box 102, the extracted keywords are listed, which can be scrolled so that a user can see all the listed keywords and select a desired one. The “ADD” button 103 is a command button for inputting an addition command. When the “ADD” button 103 is depressed, a keyword addition window (which will be described later) will be displayed so that the user can add keywords to the list. The “DEL” button 104 is also a command button for deleting a keyword. When the user scrolls the list box 102 and select a keyword (which will be highlighted as shown in FIG. 12A), and depresses the “DEL” button 104, the highlighted keyword will be deleted from the list. The deleted keyword is removed from the keywords which are candidates to be incorporated in the keyword table. The “OK” button 105 is a button for accepting the listed keywords. That is, when the user depressed the “OK” button 105, all the keywords included in the list in the list box 102 will be accepted as the keywords, which are stored in the keyword table.

FIG. 12B shows an example of the keyword addition window 111 which is displayed when the “ADD” button 103 shown in FIG. 12A is depressed. According to this example, the keyword addition window 111 includes a text box 112, an “ADD” button 113 and a “CANCEL” button 114. The user can input a keyword to be added in the text box 112 when the “ADD” button 113 is depressed, an addition command is issued so that the keyword input in the text box 112 is treated as a candidate to be stored in the keyword table. When the “CANCEL” button 114 is depressed, the keyword addition window 111 disappears and the confirmation window 101 is displayed again.

Back to FIG. 2, the setting storing unit 33 is configured to store setting information, which represents an operation setting set by the user through the operation unit 35. Typically, the setting storing unit 33 includes a non-volatile rewritable memory such as a flash memory or the like. It should be stressed that confidential keyword data is included in the setting information to be stored. The confidential keyword data will be described later.

The operation unit 35 includes a touch panel which is integrally provided on a front surface of the display unit 37, and mechanical (operable) keys provided around the display unit 37. Though the operation unit 35, the user can input various instructions.

The display unit 37 includes a display device such an LCD (Liquid Crystal Display) or an organic EL (electroluminescence) display, and displays information under control of the control unit 39.

The control unit 39 includes a CPU (Central Processing Unit), a ROM (Read Only Memory), a RAM (Random Access Memory), an SRAM (Static RAM), an I/O (input/output ports), which are interconnected through a bus line also included in the control unit 39. The control unit 39 controls the above units to carry out various operations in accordance with programs stored in the ROM.

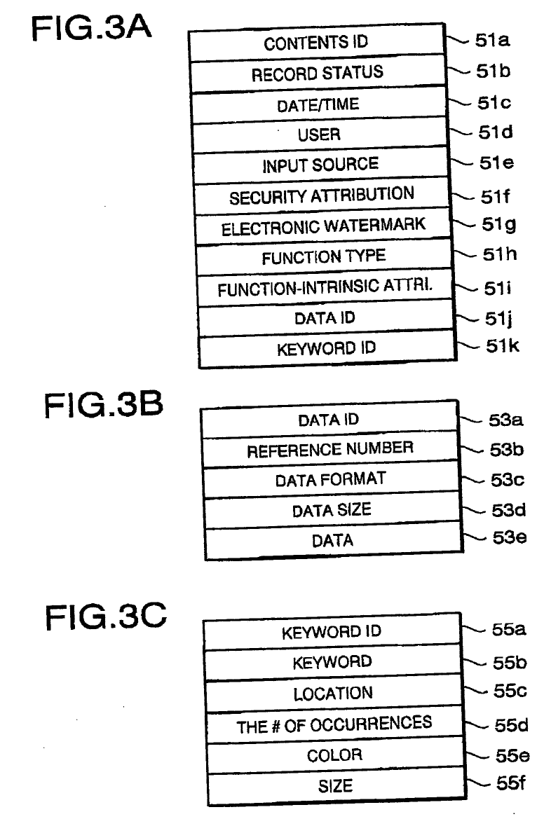

Next, referring to FIGS. 3A, 3B and 3C, the contents table, data table and keyword table stored in the data storing unit 31 will be described.

FIG. 3A shows data fields of the contents table. The contents table includes, as shown in FIG. 3A, a content ID 51a, a record status 51b, date & time 51c, a user 51d, an input source 51e, a security attribution 51f, digital watermark information 51g, a function category 51h, a functional attribution 51i, a data ID 51j and a keyword ID 51k.

The contents ID 51a is a data field in which an ID for distinguishing a record from the others is stored. The ID is assigned, in an ascending manner, to the records in the generated order.

The record status 51b is a data field in which information representing a status of the record. The status may be a locked status (update-disabled status), an invalid status (due to deletion of the record), and a suspended status.

The data & time 51c is a data filed in which the data and time when the record is generated are stored.

The user 51d is a filed in which information for identifying the user who input the data is stored. If the user cannot be identified, the user field 51d is remained as a blank field.

The input source 51e is a field in which the source from which the data is input is stored. The source of the data may be one of the LAN communication unit 13, the WAN communication unit 15, the FAX communication unit 17, the PC communication unit 23, the recording medium access unit 25, and the reading unit 29, and information identifying one of the above units is stored in the input source filed 51e. It should be noted that, according to the embodiment, when the source is the LAN communication unit 13, the WAN communication unit 15 or the FAX communication unit 17, information of the source (i.e., the IP address of the PC, the telephone number of the FAX sending station, etc.) is also stored in the input source field 51e.

The security attribution 51f is a field where the information regarding the degree of disclosure is stored. Specifically, according to the embodiment, one of “full disclosure”, “in-house disclosure”, “disclosure to partner” and “non-disclosure” is stored in the security attribution field 51f.

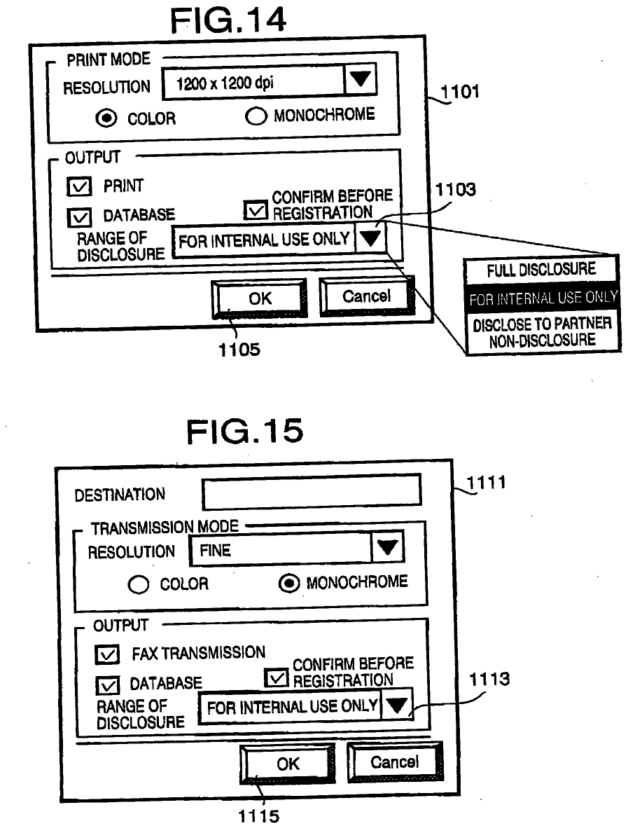

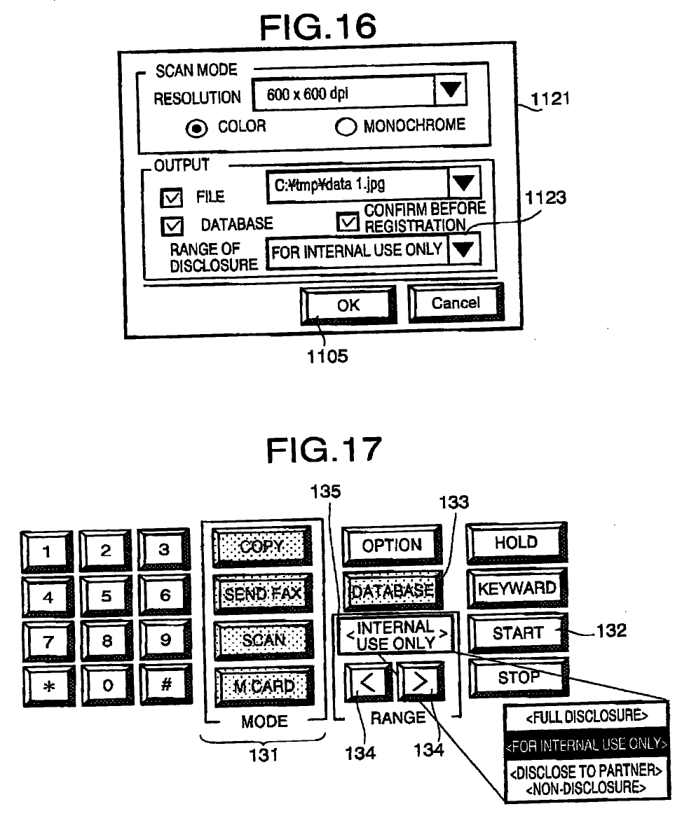

Now, referring to FIGS. 14 through 17, how the security attribution 51f is set will be described. FIG. 14 shows an example of an operation window 1101 when a printing operation is carried out according to aspects of the present invention. FIG. 15 shows an example of an operation window 1111 when a PC-FAX is transmitted according to aspects of the present invention. FIG. 16 shows an example of an operation window 1121 when a scanner function is used according to aspects of the present invention.

The operation window 1101 shown in FIG. 14 is displayed to allows the user to designate a printing attribution (e.g., a print mode, an output destination, etc.) when the user operates a terminal device to control the MFD 11 to execute a printing operation. The operation window 1101 is displayed on the monitor of the terminal device. As shown in FIG. 14, in the operation window 1101, objects for designating the print mode and output destination (print/non-print, accumulation/non-accumulation in the MFD 11, etc.) and a drop down list box 1103 for designating the disclosure range when the data is accumulated in the MFD 11 are shown. The drop down list box 1103 shows “full disclosure”, “in-house disclosure”, “disclosure to partner” and “non-disclosure”, one of which can be selected. When the user selects one of the listed items in the drop down list box 1103, and depresses an OK command button 1105, the information, as set and displayed in the operation window 1101, is transmitted to the MFD 11, which carries out the operation in accordance with the transmitted information. At that time, the range of disclosure selected in the drop down list box 1103 is recorded in the security attribution field 51f.

The operation window 1111 shown in FIG. 15 is displayed on the monitor of the terminal device when the user operates the terminal device to control the MFD 11 to carry out a facsimile transmission in order to request the user for a transmission attribution (i.e., a destination, a transmission mode, etc.). As shown in FIG. 15, on the operation window 1111, a dropdown list box 1113 for designating a range of disclosure of the data when stored in the MFD 11 is displayed as well as the objects for designating the destination and the transmission mode. In the dropdown list, items of “FULL DISCLOSURE”, “IN-HOUSE DISCLOSURE”, “DISCLOSURE TO PARTNER” and “NON-DISCLOSURE” are included, one of which can be selected. When the user selects one item from the dropdown list, and depresses the OK button 1115, the information set through the operation window 1111 is transmitted to the MFD 11 and executed thereby and/or stored therein. When the information is stored in the MFD 11, the range of the disclosure designated through the dropdown list 1113 is stored in the security attribution field 51f.

The operation window 1121 shown in FIG. 16 is displayed on the monitor of the terminal, when the user operates the terminal to control the MFD 11 to perform its scanner function, in order to allow the user to designate the scanning attribute (i.e., a scan mode, a storing file name, etc.). As shown in FIG. 16, on the operation window 1121, a dropdown list box 1123 for designating a range of disclosure of the data when stored in the MFD 11 is displayed as well as the objects for designating the scan mode and the destination storage. In the dropdown list box 1123, items of “FULL DISCLOSURE”, “IN-HOUSE DISCLOSURE”, “DISCLOSURE TO PARTNER” and “NON-DISCLOSURE” are included for selection. When the user selects one item from the dropdown list box 1123, and depresses the OK button 1125, the information set through the operation window 1121 is transmitted to the MFD 11 and executed thereby and/or stored therein. When the information is stored in the MFD 11, the range of the disclosure designated through the dropdown list 1123 is stored in the security attribution field 51f.

FIG. 17 schematically shows an example of an operation panel according to aspects of the present invention. According to the embodiment, the operation panel is provided with mode keys 1131, which are configured such that only one of the keys 1131 can be turned ON at a time, and when in the ON state, the color saturation or brightness of the key is changed. When the user depresses one of the mode keys 1131 corresponding to the function the user intends to use (i.e., one of copy, FAX, scan and M card functions), and depresses a start key 1132, the designated function is actuated. When the user intends to store data in the MFD 11, the user may depress one of the mode keys 1131, then a DB storing key 1133 (which is a toggle type key), selects one of “FULL DISCLOSURE”, “IN-HOUSE DISCLOSURE”, “DISCLOSER TO PARTNER” and “NON-DISCLOSURE” by operating the disclosure range designate key 1134 (the selection being displayed on the LCD 1135), and the user depresses the start key 1132 to start the storing operation. When the start key 1132 is operated, the range of disclosure selected at that time is stored in the security attribution 51f.

The electronic watermark data field 51g is a field that stores a code which is generated from a production number of the MFD 11 and data and time stored in the date and time data field 51c.

The function type data field 51h stores the type of the function. The “function” is one of the print function, copier function, facsimile transmission function, facsimile reception function, PC-FAX transmission function, scanner function, media print function, media storage function and main forwarding function.

The function attribution data field 51i stores attributions intrinsic to respective functions (e.g., in a case of the facsimile transmission function, the attributions include the transmission mode, transmission magnification, image scanning resolution, layout information, information representing color or monochromatic, transmission destination information, output resolution of the destination, etc.).

The data ID field 51j stores the ID for identifying the input data. Based on the ID, the input data to be stored in the data table can be identified.

The keyword ID field 51k stores the ID for identifying the keyword data. Based on the keyword ID, data related to the keyword stored in the keyword table can be identified.

Next, referring to FIG. 3B, data fields of the data table storing the input data will be described. The data table includes fields of data ID 53a, referenced number 53b, data format 53c, data size 53d, and actual data 53e.

The data ID fields 53a stores the ID for identifying respective records, and correspond to the data ID field 51j of the contents table described above.

The referenced number field 53b stores the number of records of content table whose record is being currently referred to.

The data type field 53c stores the type of the input data. The type may be, for example, print data, FAX data, JPEG data, text data, etc.

The data size field 53d stores the size of the input data.

The actual data field 53e stores the input data itself.

Next, referring to FIG. 3C, the fields of the keyword table that stores the keyword information included in the input data will be described. The keyword table includes, as shown in FIG. 3C, the fields of keyword ID 55a, keyword 55b, location 55c, the number of occurrences 55d, color 55e and size 55f.

The keyword ID field 55a stores the IDs for identifying respective records, which correspond to the keyword ID field 51k of the contents table.

The keyword field 55b stores the keyword itself. The keyword may include, for example, “For Internal Use Only”, “Patent”, “Customer Information”, etc.

The location filed 55c field stores locations in a text where the keywords are stored. For example, information representing header, body of text, footer and the like is stored.

The number of occurrences 55d stores the number of the keywords included in the data.

The color field 55e stores the color of the keyword, and the size field 55f stores the size of the letters of the keyword (unit: point).

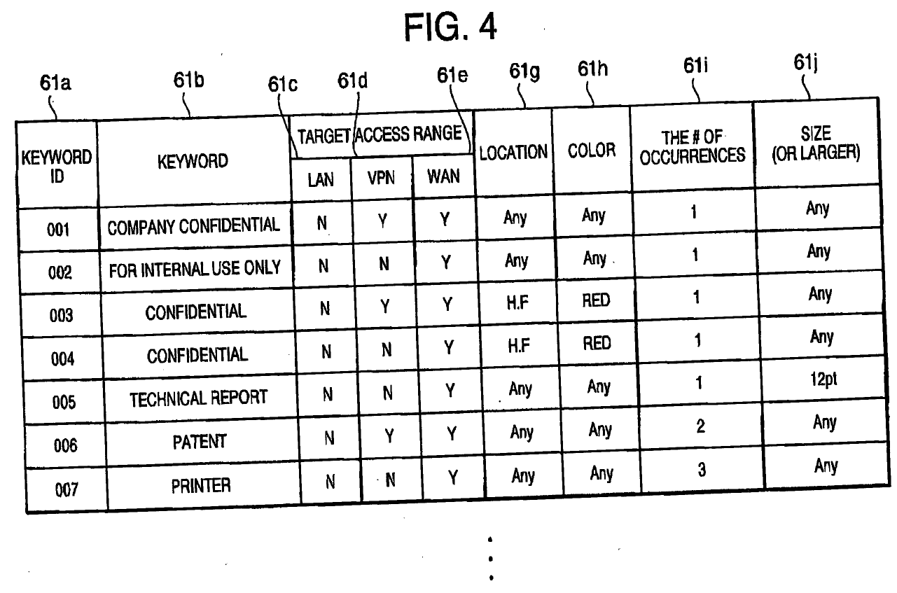

FIG. 4 shows a data structure of the confidential keyword table. The confidential keyword stored in the setting storing unit 33 will be described with reference to FIG. 4. As shown in FIG. 4, the confidential keyword data is stored in the form of a table. Each record of the confidential keyword data includes a keyword ID 61a, a keyword 61b, an access range (LAN) 61c, an access range (VPN) 61d, an access range (WAN) 61e, a location 61f, a color 61g, an occurrence 61h and a size 61i.

The keyword ID 61a is a unique ID for identifying a confidential keyword. The keyword ID 61a is automatically assigned to each piece of keyword data in the order of input.

The keyword 61b is a confidential keyword. If the keyword 61b exists, the file should be regarded as a confidential file.

The access range (LAN) 61c is a flag representing whether requested data including the keyword 61b should be regarded as a target of access restriction when the network to which the requesting terminal is connected is the LAN. If the flag (i.e., the access range (LAN) 61c) indicates “N”, the requested data is not subjected to the access restriction, and will be transmitted to the requesting terminal even if the keyword 61b is included in the requested data. If the flag indicates “Y”, the requested data is subjected to the access restriction, and a predetermined process is carried out.

The access range (VPN) 61d is a flag representing whether requested data including the keyword 61b should be regarded as a target of access restriction when the network to which the requesting terminal is connected is the VPN. The access range (WAN) 61e is a flag representing whether requested data including the keyword 61b should be regarded as a target of access restriction when the network to which the requesting terminal is connected is the WAN.

The location 61f represents a condition which the confidential keywords, which are subject to the access restriction, in the text should satisfy. For example, if the location 61f is set to “Any”, the confidential keyword at any location is subjected to the restriction. If the location 61f is “H”, only the confidential keyword located in the header is referred to, and if the location 61f is “F”, only the confidential keyword located in the footer is referred to.

The color 61g represents a condition which the confidential keywords, which are subjected to the access restriction, should satisfy in the text. For example, if the color 61g is “Any”, the confidential keyword with any color is subjected to the restriction. If the color 61g is “red”, only the red confidential keyword is subjected to the restriction.

The number of occurrences 61h represents a condition which the confidential keywords, which are subjected to the access restriction, should satisfy. If the number of occurrences 61h is set to “1”, even if the keyword appears once in the text, it is subjected to the access restriction. If the number of occurrences 61h is set to “3”, only when the keyword is used three times or more, the text is subjected to the access restriction.

The size 61i represents a condition of the letter size (i.e., the point number) of the confidential keyword to satisfy. For example, if the size 61i is “12 pt”, only when the size of the letters is 12 points or larger, the text is subjected to the access restriction. If the size is set to “Any”, the text is subjected to the access restriction regardless of the size of the letters of the text.

Registration of the confidential keywords with the confidential keyword table will be described in detail.

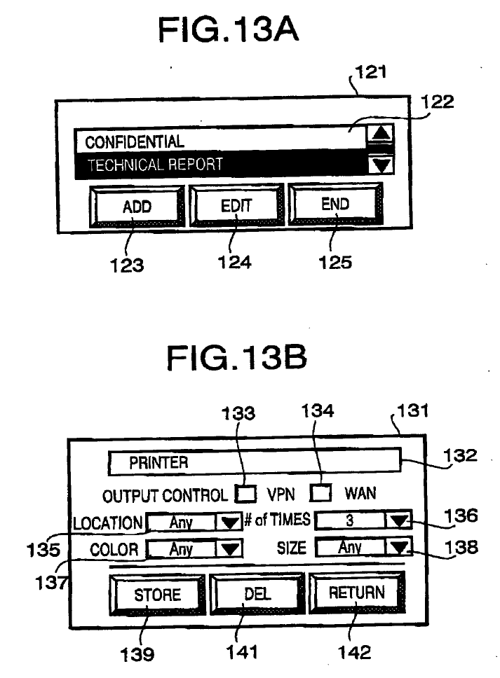

By operating the operation unit 35 or a keyboard of the terminal device, the user can display a confidential keyword editing window on the display unit 37 or a monitor of the terminal device, and register and/or edit confidential keywords. This operation will be described in detail with reference to FIGS. 13A and 13B, which show examples of input windows for registering/editing confidential keywords.

Specifically, when the user operates the operation unit 35 of the keyboard of the terminal device, an input window 121 shown in FIG. 13A is displayed on the displaying unit or monitor of the terminal device. As shown in FIG. 13A, the input window 121 includes a list box 122, an ADD button 123, and EDIT button 124, and an END button 125. The list box 122 displays the confidential keywords registered with the table such that user can scroll the registered keywords by scrolling, and select one of the confidential keywords. The “ADD” button 123 is depressed when the input window 121 as shown in FIG. 13A is displayed, another input window 131 as shown in FIG. 13B is displayed.

If the “EDIT” button 124 is clicked when the input window 121 is displayed, again the input window 131 (FIG. 13B) is displayed. In this case (i.e., when the “EDIT” button is clicked), information regarding the confidential keyword selected in the list box 122 is displayed in the input window 131. When the “END” button 125 is clicked, the input window 121 is simply closed.

The input window 131 (FIG. 13B) will be described in detail. The input window 131 includes, as shown in FIG. 13B, a text box 132, a VPN check box 133, a WAN check box 134, a location drop down list 135, a number of occurrences dropdown list 136, a color drop down list 137, a size drop down list 138, a “STORE” button 139, a “DELETE” button 141, and a “RETURN” button 142.

In the text box 132, the user can input a confidential keyword. The text box 132 corresponds to the keyword 61b of the confidential keyword table.

The VPN check box 133 is used for inputting whether the VPN is subjected to an output restriction. The VPN check box 133 corresponds to the access range (VPN) 61d of the confidential keyword table.

The WAN check box 134 is used for inputting whether the WAN is subjected to an output restriction. The WAN check box 134 corresponds to the access range (WAN) 61e of the confidential keyword table.

The location dropdown list 135 is for designating a condition regarding the location of the confidential keyword. The location dropdown list 135 corresponds to the location field 61f of the confidential keyword table. Through the location dropdown list 135, one of “Any” (any location), “H” (header), “F” (footer), and “HF” (header and footer) can be designated as the location condition to be satisfied.

The number of occurrences dropdown list 136 is for designating the condition of the number of occurrences of the keyword in a text. The number of occurrences dropdown list 136 corresponds to the number of occurrences 61h of the confidential keyword table. In this illustrative embodiment, the user can select one of “1”, “2”, “3”, “4” and “5” as the number of occurrences to be satisfied (i.e., the number of occurrences of the confidential keywords should be equal to or more than the designated number to satisfy the condition).

The condition of the color to be satisfied by the confidential keyword can be selected through the color dropdown list 137, which corresponds to the color 61g of the confidential keyword table. The user can select one of “Any”, “Black”, “Red”, “Blue”, and “Yellow” etc. through the color dropdown list 137.

The condition of the size of the letters of the confidential keyword can be selected through the size dropdown list 138, which corresponds to the size 61i of the confidential keyword table. The user can select one of “Any”, “10 Pt”, “12 pt”, “14 pt” and “16 pt or larger”.

When the “STORE” button 139 is clicked, the input keyword and selections as displayed on the input screen 131 are added to the confidential keyword table (or the confidential keyword table is updated with the newly designated selections as displayed on the input screen 131). It should be noted that, when the data (record) is added or updated, the keyword input in the text box 132 is used as a unique key.

When the “DELETE” button 141 is clicked, the record corresponding to the keyword as input in the text box 132 is deleted from the confidential keyword table.

When the “RETURN” button 142 is clicked, the input window 131 will disappear and the input window 121 shown in FIG. 12A will be displayed.

Hereinafter, procedures executed by the control unit 39 will be described with reference to flowcharts. It should be noted, however, only the procedure related to a browsing request from the terminal device will be described, and the ordinary data storing procedures that are generally performed by the MFD will be omitted for brevity since such ordinary procedures are well-known. Specifically, a browsing procedure, a browsing image generating procedure, which is called in the browsing procedure, and a confidential keyword checking procedure, which is called in the browsing image generating procedure, will be described in detail.

Browsing Procedure

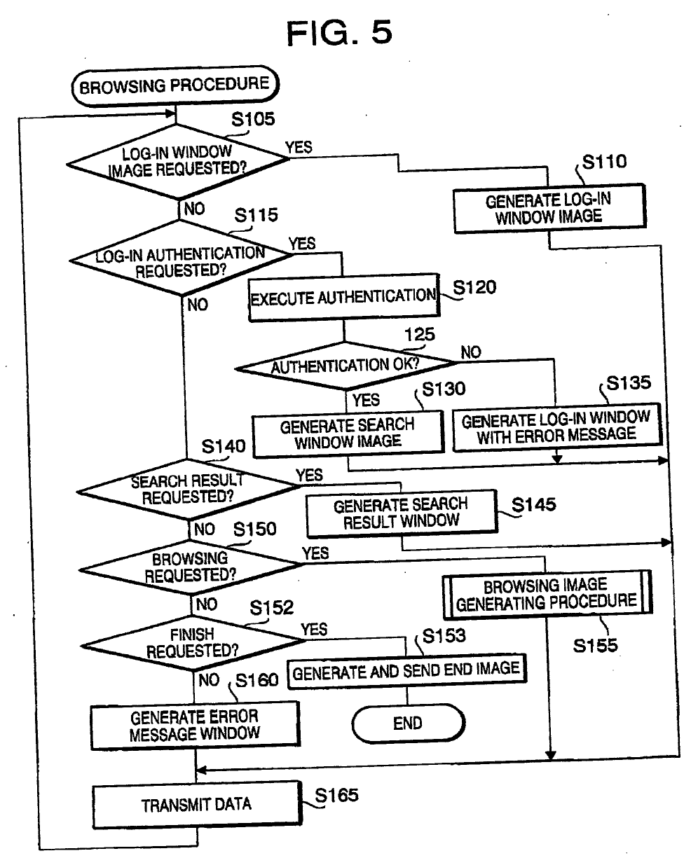

FIG. 5 shows a flowchart illustrating the browsing procedure executed by the control unit 39. The browsing procedure is started when a request related to browsing is issued by a terminal device connected to the LAN or WAN.

When the browsing procedure is started, the control judges whether the terminal device requests for a log-in window image (S105). If the terminal device requests for the log-in window image (S105: YES), the process proceeds to S110.

In S110, the process generates the log-in window image. When the log-in window image has been generated, the process proceeds to S165. In S165, the generated log-in window image is transmitted to the terminal device.

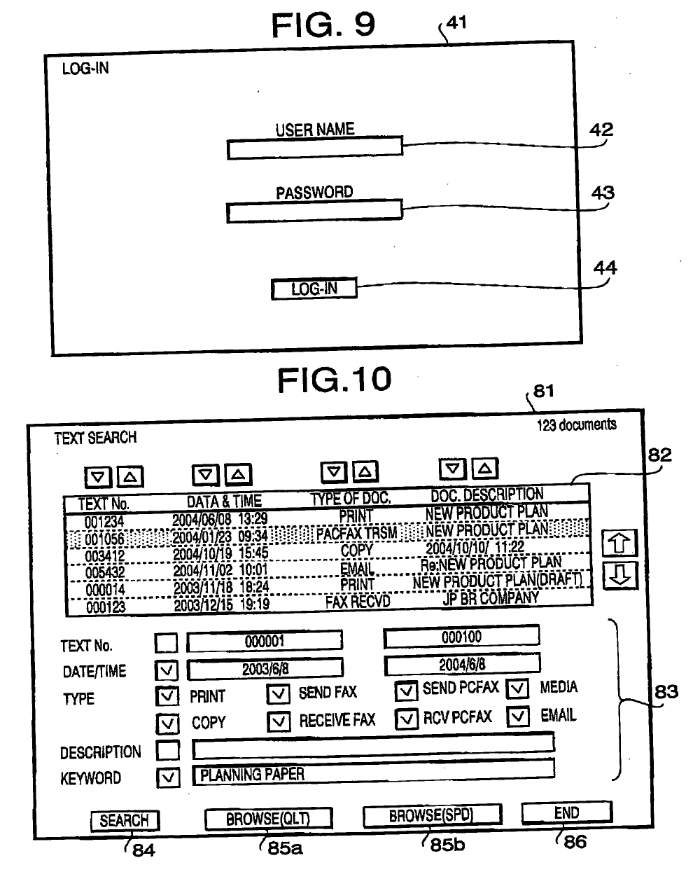

FIG. 9 shows an example of the log-in window image 41, which is displayed at the terminal device side. The log-in window image 41 includes, as shown in FIG. 9, a text box 42 for inputting a user name, a password text box 43, and a log-in command button 44. The user can type the user name in text box 42, and type the password in the password text box 43. When the user input the user name and the password in the text box 42 and the password text box 43, respectively, and when the user clicks the log-in command button 44, a log-in authentication request is transmitted from the terminal device to the MFD 11.

If the terminal device does not request for the log-in window image (S105: NO), the process proceeds to S115. In S115, the process judges whether the terminal device requests for the log-in authentication (S115). If the terminal device requests for the log-in authentication (S115: YES), the process proceeds to S120. If the terminal device does not request for the log-in authentication (S115: NO), the process proceeds to S140.

In S120, the process executes the log-in authentication. Specifically, in this authentication step, the process receives the user name and password input through the log-in window image, and judges wither the combination of the received user name and password is identical to the one stored in the setting storing unit 33.

In S125, the process judges whether authentication is successful. If the authentication has been succeeded (S125: YES), the process proceeds to S130. If the authentication has not been successful (S125: NO), the process proceeds to S135.

In S130 (i.e., when the authentication was successful), the process generates a search window image. When the search window image has been generated, the process proceeds to S165, and transmits the thus generated search window image to the terminal device (S165).

FIG. 10 shows an example of the search window image 81 displayed at the terminal device. The search window image 81 includes, as shown in FIG. 10, a gird 82, a condition terminal device. It should be noted that the search result display window image is similar to the search window image 81 (see FIG. 10). Thus, the contents of the grid 82 are updated, and only the documents that meet the conditions input in the condition input box group 83 are displayed in the grid 82.

In S150, the process diverges depending on whether the terminal device has issued the browsing request. Specifically, the process diverges depending on whether the browse (quality-priority) button 85a or the browse (DL speed priority) button 85b has been clicked or not. If the terminal device requests for the browsing, the process proceeds to S155, otherwise to S152.

As described above, when the terminal device requests for the browsing, the process proceeds to S155. In S155, the browse image generating procedure is executed, which will be described in detail later. After the browse image generating procedure is completed, the process proceeds to S165.

If the terminal device does not request for the browsing (S150: NO), the process proceeds to S152, where the process diverges depending on whether the terminal device requests for end of the procedure. If the terminal device requests for completion of the procedure (S152: YES), the process proceeds to S153. If the terminal device does not request for the completion of the procedures (S152: NO), the process proceeds to S160.

In S153, the process generates an ending image, transmits the generated image to the terminal device, and finishes the browsing procedure. The ending image may be an image indicating the log-out is done. It should be noted that the image need not be limited to one exemplified above and any appropriate image may be used, or the image may be omitted.

If the terminal device does not request for the completion of the procedure (S152: NO), in S160, the process generates an error message displaying window image and proceeds to S165, where the process transmits the thus generated error message displaying window image to the terminal device. The error message may be “UNUSUAL REQUEST HAS BEEN RECEIVED”, for example.

As described above, in S165, the image generated in S110, S130, S135, S145, S155 or S160 is transmitted to the terminal device. Thereafter, the process returns to S105.

Browsing Image Generating Procedure

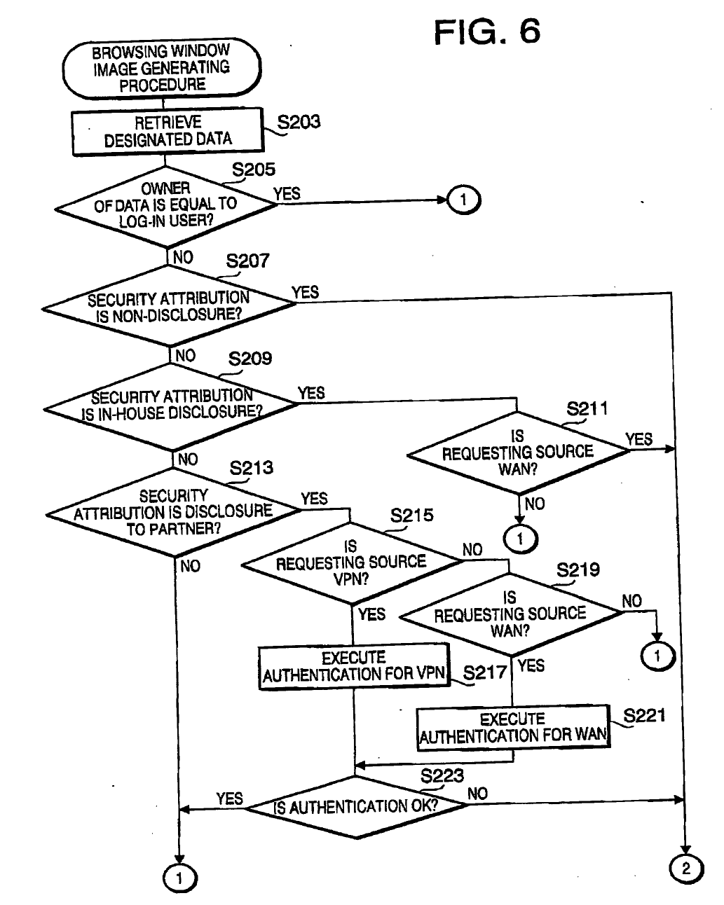

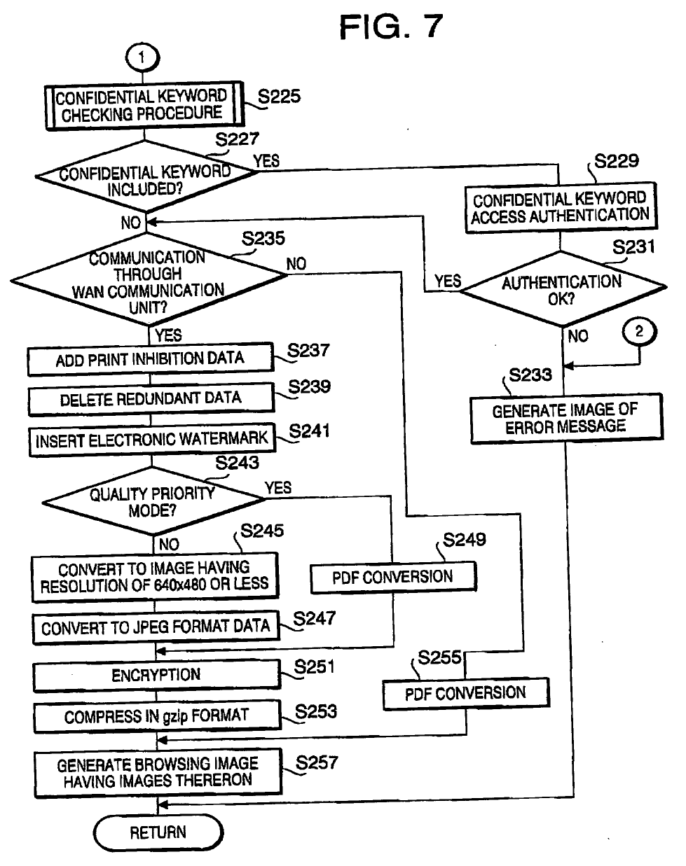

Referring to FIGS. 6 and 7, the browsing image generating procedure will be input box group 83, a search button 84, a browse (quality-priority) button 85a, a browse (DL speed-priority) button 85b and end button 86.

The grid 82 shows a document number, date/time of recordation, document type (print/FAX/copy), document information (title, author, etc.) for each document. The user can make a selection on a document basis. The condition input box group 83 includes boxes in which conditions for narrowing down the documents displayed in the grid 82 can be input. Specifically, the user can input conditions for at least one of the document number, date/time, type of document, document information and keyword through the condition input box group 83. After inputting the condition, when the user clicks the search button 84, the number of documents displayed in the grid 82 can be reduced (i.e., the selection can be narrowed). That is, the search button 84 functions to carry out the narrowing of the documents displayed in the grid 82.

The browse (quality-priority) button 85a is operated when the user intends to browse the document selected in the grid 82 in a quality-priority mode. The browse (DL speed-priority button 85b is operated when the user intends to browse the document selected in the grid 82 in a download speed priority mode. When the end button 86 is operated, the search window image disappears.

If the authentication is failed (S125: NO), the process proceeds to S135, where the process generates another log-in window image having an error message. The log-in window image generated in S135 is similar to the window 41 shown in FIG. 9 except that, in addition to the image shown in FIG. 9, the error message (e.g., “AUTHENTICATION IS FAILED”) is indicated in the window 41.

In S115, if the terminal device does not request for the log-in authentication (S115: NO), the process proceeds to S140. In S140, the process judges whether the terminal device requests for the search result. That is, the process diverges, in S140, whether the search button 84 of the search window image 81 (see FIG. 10) has been clicked or not. If the terminal device requests for the search result (S140: YES), the process proceeds to S145. If the terminal device does not request for the search result (S140: NO), the process proceeds to S150.

In S145, the process carries out the searching operation in accordance with the conditions input through the condition input box group 83 (see FIG. 10), and generates a search result display window image. After the search result display window image is generated, the process proceeds to S165, where the thus generated image is transmitted to the described in detail. The browsing image generating procedure is called in the browsing procedure described above.

When the browsing image generating procedure is started, the process retrieves the requested data from the data storing unit 31 (specifically, from the contents table, data table and keyword table) in S203.

Then, based on the retrieved data, the process judges whether the owner of the data is identical to the user who has carried out the log-in authentication (S205). If the owner of the data is equal to the authenticated user (S205: YES), the process proceeds to S225 (see FIG. 7). If the owner of the data is not equal to the authenticated user (S205: NO), the process proceeds to S207.

In S207, the process diverges depending on the security attribution of the data (i.e., the data stored in the security attribution field 51f of the contents table). If the security attribution is “NON-DISCLOSURE” (S207: YES), then the process proceeds to S233 (FIG. 7). If the security attribution is not “NON-DISCLOSURE” (S207: NO), the process proceeds to S209.

In S209, the process judges whether the security attribution is “IN-HOUSE DISCLOSURE”. If the security attribution is “IN-HOUSE DISCLOSURE” (S209: YES), the process proceeds to S211. If the security attribution is not “IN-HOUSE DISCLOSURE” (S209: NO), the process proceeds to S213.

In S211, the process judges whether the requesting terminal device is connected to the WAN (including VPN) or not. If the terminal device that has issued the request is connected to the WAN (including VPN), the process proceeds to S233, while if the terminal device is not connected to the WAN (including VPN), the process proceeds to S225.

In S213, the process judges whether the security attribution is “DISCLOSE TO PARTNER” or not. If the security attribution is “DISCLOSE TO PARTNER” (S213: YES), the process proceeds to S215, while if the security attribution is not “DISCLOSE TO PARTNER” (S213: NO), the process proceeds to S225.

In S215, the process judges whether the type of the network to which the requesting terminal device is connected is the VPN. If the network is the VPN (S215: YES), the process proceeds to S217, while if the network is not the VPN (S215: NO), the process proceeds to S219.

In S217, the process carries out the authentication for the VPN, and then proceeds to S223. The authentication for the VPN is, for example, to request the terminal device for further user name and password for the VPN authentication, or an authentication using electronic certification by requesting the same from the terminal device.

In S219, the process judges whether the requesting terminal device is connected to the WAN (non-VPN). If the terminal device is connected to the WAN (non-VPN) (S219: YES), the process proceeds to S221. If the terminal device is not connected to the WAN (non-VPN) (S219: NO), the process proceeds to S225 (see FIG. 7).

In S221, the process performs the authentication of the WAN and then proceeds to S223. The authentication for the WAN is, for example, to request the terminal device for further user name and password for the WAN authentication, or an authentication using electronic certification by requesting the same from the terminal device.

In S223, the process judges whether the authentication has been performed successfully. If the authentication has been performed successfully (S223: YES), the process proceeds to S225. If the authentication has been failed (S223: NO), the process proceeds to S233 (see FIG. 7).

In S225, the confidential keyword checking procedure is executed. The confidential keyword checking procedure is a procedure to check whether a confidential keyword is included in the target data. The confidential keyword checking procedure will be described later in detail with reference to a flowchart.

In S227, the process judges whether the confidential keyword is included in the browsing target data (S227) based on the result of the confidential keyword checking procedure. If the confidential keyword is included in the browse target data (S227: YES), the process proceeds to S229. If the confidential keyword is not included in the target data (S227: NO), the process proceeds to S235.

In S229, the process executes the authentication for the confidential keyword access. The authentication for the confidential keyword access is, for example, to request the terminal device for further user name and password for the authentication, or an authentication using electronic certification by requesting the same from the terminal device.

In S231, the process judges whether the authentication in S229 has been executed successfully. If the authentication is successful (S231: YES), the process proceeds to S235. If the authentication has been failed (S231: NO), the process proceeds to S233.

In S233, the process generates an error message indication image. The error message indication image is an image in which a message notifying that the authentication for the confidential keyword access has been failed. After the error message has been generated, the process finishes the procedure (i.e., the browsing image generating procedure), and returns to a position in the browsing procedure where the browsing image generating procedure was called (i.e., S155 of FIG. 5).

In S235, the process judges whether a communication is performed with the requesting terminal device through the WAN communication unit 15. If the communication is performed with the terminal device through the WAN communication unit 15 (S235: YES), the process proceeds to S237. If the communication with the terminal device is not performed through the WAN communication unit 15 (S235: NO), that is, when the communication is performed through the LAN communication unit 13, the process proceeds to S255.

In S255, the process converts the target data subject to the browsing into PDF data. Then, the process proceeds to S257.

In S237, the process adds print inhibition data to the target data (subject to the browsing). Then, the process removes redundant data (e.g., blank data, unnecessary attribution data, etc.) from the target data (S239), and inserts electronic watermark data (S241).

In S243, the process judges whether the request for the browsing is in the quality-priority mode. If the quality-priority mode has been selected (i.e., the browse (quality-priority) button 85a has been clicked) (S243: YES), the process proceeds to S249. If the DL speed priority mode has been selected (i.e., the browse (DL speed priority) button 85b has been clicked) (S243: NO), the process proceeds to S245.

In S249, the process converts the target data to the PDF data, and proceeds to S251.

In S245, the target data is downsized to have a resolution of 640 dots×480 dots or less with maintaining the aspect ratio constant. Then, the process further converts the reduced data to JPEG (ISO/IEC 10918-1) format data (S247), and proceeds to S251.

In S251, the process encrypts the thus converted data in accordance with a predetermined encrypting algorithm such as DES or MD5. Then, the process compresses the encrypted data in a gzip (RFC1952) format (S253), and proceeds to S257.

In S257, the process generates a browsing image to which the data compressed in S253, or the data converted into the PDF format in S255 is applied. An example of such a browsing image will be described with reference to FIG. 11.

FIG. 11 shows the browsing image (at the terminal device side) 91 generated in S257 of FIG. 7. The browsing image 91 includes, as shown in FIG. 11, a data displaying area 92, an attribution displaying area 93, and a “RETURN” button 94. The data displaying area 92 is an area in which the target data is displayed. In the data displaying area 92, the browsing data (image data) compressed in the gzip (RFC1952) format and/or the PDF data transmitted from the MFD 11 is decompressed and displayed. The attribution displaying area 93 is an area where the attribution of the data that is displayed in the data displaying area is displayed. The “RETURN” button 94 is for switching the displayed window to the text searching window.

When the browsing image has been generated, the current procedure (i.e., the browsing image generating procedure) is finished, and the procedure returns to the position where the browsing image generating procedure was called (i.e., S155 of FIG. 5).

Confidential Keyword Checking Procedure

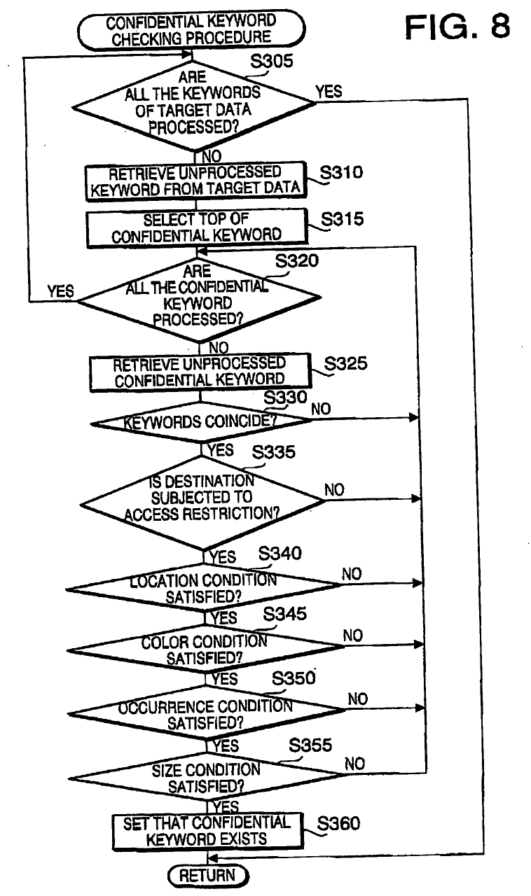

Next, the confidential keyword checking procedure will be described with reference to FIG. 8. The confidential keyword checking procedure is called when the above-described browsing image generating procedure is being executed.

When the confidential keyword checking procedure is executed, the process judges whether all the keywords included in the browsing target data (i.e., all the keywords stored in the keyword table related to the browsing target data) have been subjected to the step S310 (described later) in S305.

If one or some of the keywords for the browsing target data has not yet been subjected to the process of S310 (S305: NO), the process proceeds to S310, where a record corresponding to one of the unprocessed keywords is retrieved from the keyword table.

In S315, a top record of the confidential keyword data stored in the confidential keyword table is selected.

In S320, the process judges whether all the pieces of the confidential keyword data stored in the confidential keyword table have been subjected to the process of S325 (described later). It should be noted that, every time when the top record of the confidential keyword data stored in the confidential keyword table is selected in S315, all the pieces of the keyword data are initialized (i.e., set to unprocessed state).

If all the pieces of the confidential keyword data have been subjected to the process of S325 (S320: YES), the process returns to S305. If one or some pieces of the confidential keyword data have not yet been subjected to the process of S325 (S320: NO), the process proceeds to S325, where one record of the non-processed confidential keyword data is retrieved.

In S330, the process judges whether the keyword of the retrieved confidential keyword data coincides with the keyword of the browsing target data (i.e., the keyword retrieved in S310). If the keyword of the retrieved confidential keyword data coincides with the keyword of the browsing target data (S330: YES), the process proceeds to S335. Otherwise, the process returns to S320.

In S335, the process judges whether the type of the network of the requesting terminal device is subjected to the access limitation, for the retrieved confidential keyword data. If the type of the network of the requesting terminal device is subjected to the access limitation (S335: YES), the process proceeds to S340. Otherwise, the process returns to S320.

In S340, the process judges whether the location of the keyword (retrieved in S310) of the browsing target data satisfies the location condition of the retrieved confidential keyword data. If the location of the keyword of the browsing target data satisfies the location condition of the retrieved confidential keyword data (S340: YES), the process proceeds to S345. Otherwise, the process returns to S320.

In S345, the process judges whether the color of the keyword of the browsing target data (retrieved in S310) satisfies the color condition of the retrieved confidential keyword data. If the keyword of the browsing target data satisfies the color condition of the retrieved confidential keyword data (S345: YES), the process proceeds to S350. Otherwise, the process returns to S320.

In S350, the process judges whether the number of occurrences of the keyword of the browsing target data (retrieved in S310) satisfies the number of occurrences condition of the retrieved confidential keyword data. If the keyword of the browsing target data satisfies the number of occurrences condition of the retrieved confidential keyword data (S350: YES), the process proceeds to S355. Otherwise, the process returns to S320.

In S355, the process judges whether the letter size of the keyword of the browsing target data (retrieved in S310) satisfies the letter size condition of the retrieved confidential keyword data. If the keyword of the browsing target data satisfies the letter size condition of the retrieved confidential keyword data (S355: YES), the process proceeds to S360. Otherwise, the process returns to S320.

In S360 (i.e., if the keyword of the browsing target data satisfies the above-described conditions of the confidential keyword), the process determines that the confidential keyword is included, and the confidential keyword checking procedure is finished. Then, the process returns to a position where the confidential keyword checking procedure was called (S225 of FIG. 7).

According to the above-described network system 1 described above, the owner of the file (or a system administrator) need not set the security attribution (e.g., the password) to each file, and the confidentiality of each file can be maintained. Whether a file is confidential of not can be automatically determined, when the file is transmitted, based on the keyword contained in the file, without requiring the owner (or administrator) to carry out a specific operation, no mistakes of the owner (or administrator) will occur. Therefore, a case where a confidential file is laid open, or a file to be laid open is erroneously made confidential will not occur.

Further, according to the above-described embodiment, it is not necessary to change the confidentiality setting for each file as is conventionally done. Only by changing the confidential keyword stored in the confidential keyword table, security policy can be changed at a time. Therefore, the owner (administrator) of the files is free from troublesome setting works.

Furthermore, according to the MFD 11 according to the above-described embodiment, the authentication procedure (S217, S221 of FIG. 5) is executed depending on the type of the network (LAN, WAN or VPN) the terminal device is connected. Therefore, when a plurality of pieces of data is stored in the MFD 11, the user need not set different passwords for each piece of data. Further, different from a method using different passwords for different users, security of the data is maintained for different terminal devices at different locations (e.g., a terminal device connected to an in-house network and a terminal device connected to the Internet). Therefore, appropriate degree of security can be kept for the data regardless of the location of the terminal devices.

Still further, according to the MFD 11 described above, when data is stored in the MFD 11, the user can set a range of disclosure. Therefore, a variety of ways of security settings can be realized.

Modification

The MFD 11 described above is configured to determine whether the target file is confidential or not by searching a keyword table for a confidential keyword. This configuration may be modified such that whether a confidential keyword is included or not is determined when the target file is to be transmitted. According to such a modified configuration, a response at the terminal device when browsing may be relatively lowered; however, an operation to extract a keyword when a file is stored in the MFD 11 can be omitted, thereby a time period for storing a file in the MFD 11 being reduced. Further, when a method to extract a keyword from a file is to be changed, it will not necessary to re-execute the keyword extraction process for all the files, and the method of extracting the keyword can be changed relatively easily.

It may be possible to configure a file network system in various ways. For example, the MFD 11 described above may be modified such that a data storing unit 31 is omitted therefrom. Then, the data storing unit 31 is used as an independent device (a unit separate from the MFD) and the file network system may be configured as a combination of the modified MFD, data storing device and terminal devices. In such a case, the MFD retrieves data from the file storing device, and then carries out the above-described procedures to transmit the data to the terminal device. The file network system having such a configuration operates similarly to the file network system 1 described above.

In the embodiment above, when the data is stored in the MFD 11, the user can set the range of disclosure. When the facsimile data received and stored in the MFD 11, if a list of ranges of disclosure corresponding to telephone numbers of sending stations is prepared, and the received facsimile data is stored in accordance with the range of disclosure which is automatically set based on the telephone number of the sending station, the facsimile data can be stored with appropriate range of disclosure.

What is claimed is:

1. A file transmitting device configured to transmit a designated file to an external device, comprising:
a file storage configured to store files to be laid open;
a communication system connected to a network, the file transmitting device being able to communicate with the external device through the network;
a file retrieving system that retrieves the designated file from the file storage;
a judging system configured to judge whether the retrieved file is a confidential file based on word information included in the retrieved file; and
a controlling system configured to apply an appropriate security process to the retrieved file in accordance with a result of judging of the judging system, the retrieved file being transmitted to the external device through the network.

2. The file transmitting device according to claim 1, wherein the controlling system inhibits transmitting the retrieved file if the judging system determines that the retrieved file is a confidential file.

3. The file transmitting device according to claim 1,
further comprising a keyword storage configured to store a predetermined keyword,
wherein the judging system judges that the file is the confidential file if the predetermined keyword is included in the file, while the judging system judges that the file is a non-confidential file if the predetermined keyword is not included in the file.

4. The file transmitting device according to claim 3, further comprising a receiving system configured to receive a word equivalent to the confidential keyword stored in the keyword storage and stores the received word in the keyword storage as the confidential keyword.

5. The file transmitting device according to claim 3,
wherein the keyword storage further stores a predetermined condition in association with each confidential keyword, and
wherein the judging system judges with taking the predetermined condition into account.

6. The file transmitting device according to claim 5,
wherein the predetermined condition the keyword storage stores includes a type of a network which is used when the control system transmits the file to the external device via the communication system.

7. The file transmitting device according to claim 6,
wherein the network includes a local area network and a wide area network.

8. The file transmitting device according to claim 7,
wherein the wide area network includes a virtual private network.

9. The file transmitting device according to claim 5,
wherein the predetermined condition stored in the keyword storage includes locations of the confidential keyword if contents of the file is displayed or printed.

10. The file transmitting device according to claim 5,
wherein the predetermined condition stored in the keyword storage includes a color of the confidential keyword if contents of the file is displayed or printed.

11. The file transmitting device according to claim 5,
wherein the predetermined condition stored in the keyword storage includes the number of occurrences of the confidential keyword if contents of the file is displayed or printed.

12. The file transmitting device according to claim 5,
wherein the predetermined condition stored in the keyword storage includes the size of the confidential keyword if contents of the file is displayed or printed.

13. The file transmitting device according to claim 5, further comprising a receiving system configured to receive a word equivalent to at least one of the confidential keyword and the predetermined condition stored in the keyword storage and stores the received word, which represents the at least one of the confidential keyword and the predetermined condition in the keyword storage.

14. The file transmitting device according to claim 1, further comprising a keyword storage configured to store a predetermined confidential keyword,
wherein the file storage also stores in-text keyword information containing some of keywords, in association with the file, included in the file,
wherein the judging system judges the file as the confidential file if the predetermined confidential keyword is included in the in-text keyword information corresponding to the file, while the judging system judges the file as the non-confidential file if the predetermined confidential keyword is not included in the in-text keyword information corresponding to the file.

15. The file transmitting device according to claim 14, further comprising a receiving system configured to receive a word equivalent to the confidential keyword stored in the keyword storage and stores the received word in the keyword storage as the confidential keyword.

16. The file transmitting device according to claim 14,
wherein the keyword storage further stores a predetermined condition in association with each confidential keyword, and
wherein the judging system judges with taking the predetermined condition into account.

17. The file transmitting device according to claim 16, further comprising a receiving system configured to receive a word equivalent to at least one of the confidential keyword and the predetermined condition stored in the keyword storage and stores the received word, which represents the at least one of the confidential keyword and the predetermined condition in the keyword storage.

18. A file network system, comprising:
a file transmitting device configured to transmit a file through a network; and
a terminal device configured to communicate with the file transmitting device through the network, the terminal device being capable of requesting the file transmitting device to transmit a file and receiving the transmitted file through the network,
the file transmitting device including:
a file storage configured to store files to be laid open;
a communication system connected to the network, the file transmitting device being able to communicate with the terminal device through the network;
a file retrieving system that retrieves the file requested by the terminal device from the file storage;
a judging system configured to judge whether the retrieved file is a confidential file based on word information included in the retrieved file; and
a controlling system configured to apply an appropriate security process to the retrieved file in accordance with a result of judgment by the judging system, the retrieved file being transmitted to the terminal device through the network.

19. A file network system, comprising:
a file storage configured to store files to be laid open;
a file transmitting device; and
a terminal device capable of communicating with the file transmitting device,
wherein the terminal device is capable of requesting the file transmitting device to transmit a designated file,
wherein the file transmitting device includes:
a file retrieving system configured to retrieve the designated file from the file storage in response to the request from the terminal device;
a judging system configured to judge whether the retrieved file is a confidential file based on word information included in the retrieved file; and
a controlling system configured to apply an appropriate security process to the retrieved file in accordance with a result of judgment of the judging system, the retrieved file being transmitted to the terminal device.

20. A multi-function device configured to execute a plurality of functions, comprising:
a data storage configured to store input data, the stored data being able to be output afterward to a terminal device through a predetermined network; and
a control system configured to execute one of a plurality of predetermined security processes, when the data is to be output, in accordance with a type of the predetermined network, the data being transmitted to the terminal device in accordance with a result of the executed predetermined security process.

21. The multi-function device according to claim 20, wherein the control system judges whether the predetermined network is a LAN or a WAN, and executes a predetermined security process corresponding to the result of judgment.

22. The multi-function device according to claim 20, wherein the control system judges whether the predetermined network is a LAN, a WAN or a VPN configured on the WAN, and executes a predetermined security process corresponding to the result of judgment.

23. The multi-function device according to claim 20, wherein the predetermined security process includes an authentication process corresponding to the type of the predetermined network judged by the control system.

24. The multi-function device according to claim 20, wherein the control system does not execute the predetermined security process if the type of the predetermined network is a predetermined type.

25. The multi-function device according to claim 20, wherein the control system executes the predetermined security process in accordance with attribution assigned to the data to be output in addition to the type of the network.

26. The multi-function device according to claim 25, further including:
an attribution assigning system configured to assign attribution to data when the data is input to the multi-function device; and
an attribution storing system that stores the attribution assigned to the data in association with the data.

27. The multi-function device according to claim 26, further including an operation acquiring system that acquires an operation of a user, the attribution assigning system assigning the attribution to the data in accordance with the operation performed by the user.

28. The multi-function device according to claim 26, further including an automatic receiving system configured to automatically receive input data and store the received data, the attribution assigning system assigning attribution to the automatically received data based on information regarding a sending source of the automatically received data.

29. The multi-function device according to claim 28,
wherein the attribution assigning system includes data representing a correspondence between telephone numbers and corresponding attribution settings,
wherein, when the automatically received data is facsimile data using a facsimile receiving function, the attribution assigning system identifies an attribution setting corresponding to a telephone number of a sending station of the facsimile data from among the data representing the correspondence between telephone numbers and corresponding attribution settings, the identified attribution setting being stored in the attribution storing system.

30. A file network system, comprising:
a file transmitting device; and
a terminal device connected with the file transmitting device through a predetermined network,
the file transmitting device including:
a data storage configured to store input data, the stored data being able to be output to the terminal device through the predetermined network;
a condition detecting system configured to detect a condition regarding a file transmission from the file transmitting device to the terminal device through the predetermined network; and
a control system configured to execute one of a plurality of predetermined processes, when the data is to be output, in accordance with the condition detected by the condition detecting system, the data being transmitted to the terminal device in accordance with a result of the executed predetermined process.

31. The file network system according to claim 30,
wherein the condition regarding the file transmission includes an attribution of the data to be transmitted.

32. The file network system according to claim 30,
wherein the condition regarding the file transmission includes a type of the predetermined network.

33. The file network system according to claim 30,
wherein the predetermined process includes an authentication process.

34. The file network system according to claim 30,
wherein the predetermined process includes a process applying a security setting to the data to be transmitted.

35. A computer readable medium having a program stored thereon, said program comprising computer-readable instructions that cause a computer to execute file transmitting process for transmitting a designated file to an external device which is connected to the computer through a predetermined network, the instructions cause the computer to:
judge whether the file to be transmitted is a confidential file based on word information included in the retrieved file; and
apply an appropriate security process to the retrieved file in accordance with a result of judgment, the file being transmitted to the external device through the predetermined network.

36. A computer-readable medium having a program stored thereon, said program comprising computer readable instructions that cause a computer to execute file transmitting process for transmitting a designated file to an external device which is connected to the computer through a predetermined network, the instructions cause the computer to:
detect a type of the predetermined network; and
execute one of a plurality of predetermined security processes, when the data is to be output, in accordance with a type of the predetermined network, the data being transmitted to the terminal device in accordance with a result of the executed predetermined security process.

37. A computer-implemented method for causing a computer to execute a file transmitting process for transmitting a designated file to an external device which is connected to the computer through a predetermined network, comprising the steps of:
judging whether the file to be transmitted is a confidential file based on word information included in the retrieved file; and
appling an appropriate security process to the retrieved file in accordance with a result of judgment, the file being transmitted to the external device through the predetermined network.

38. A computer-implemented method for causing a computer to execute a file transmitting process for transmitting a designated file to an external device which is connected to the computer through a predetermined network, comprising the steps of:
detecting a type of the predetermined network; and
executing one of a plurality of predetermined security processes, when the data is to be output, in accordance with a type of the predetermined network, the data being transmitted to the terminal device in accordance with a result of the executed predetermined security process.
